(19) United States
(12) Patent Application Publication
(10) Pub. No.: US 2025/0196130 A1
(43) Pub. Date: Jun. 19, 2025

(54) Fluid Device and Method for Manufacturing Fluid Devices

(71) Applicants: iXflow, inc., Kanagawa (JP); NIKON CORPORATION, Tokyo (JP)

(72) Inventors: Naoya ISHIZAWA, Tokyo (JP); Ryo KOBAYASHI, Tokyo (JP); Makiko TAKUBO, Tokyo (JP); Hirofumi SHIONO, Kanagawa (JP); Hideyuki NAKAYA, Kanagawa (JP)

(21) Appl. No.: 18/988,536

(22) Filed: Dec. 19, 2024

Related U.S. Application Data
(63) Continuation of application No. PCT/JP2023/022510, filed on Jun. 16, 2023.

(30) Foreign Application Priority Data
Jun. 23, 2022 (JP) 2022-101458

(51) Int. Cl. B01L 3/00; B32B 3/30; B32B 27/08; B32B 37/06

(52) U.S. Cl. CPC B01L 3/502707; B01L 3/502715; B32B 3/30; B32B 27/08; B32B 37/06; B01L 2200/12; B01L 2300/0816; B01L 2300/0883; B01L 2300/0887; B01L 2300/168; B32B 2250/03; B32B 2250/24; B32B 2307/20; B32B 2307/7376

(57) ABSTRACT

A method for manufacturing a fluidic device comprises: forming a laminate including a first substrate made from resin material transmissive to laser light, an intermediate layer stacked on the first substrate and made from resin material absorptive to the laser light, and a second substrate stacked on the intermediate layer and made from resin material transmissive to the laser light; and welding the first substrate and the intermediate layer, and the intermediate layer and the second substrate, by irradiating the laminate with laser light from the direction of the first or the second substrate and melting the intermediate layer over the entire thickness direction in an area irradiated with the laser light, wherein the forming includes forming a flow channel in a contact surface of the first or the second substrate with the intermediate layer; or forming a penetration area penetrating in the stacked direction in the intermediate layer.

### CROSS-REFERENCE TO RELATED APPLICATIONS

The present application is a continuation application of PCT international application number PCT/JP2023/022510 filed on Jun. 16, 2023, claiming the benefit of priority from Japanese patent application number 2022-101458 filed on Jun. 23, 2022 and designating the United States. The entirety of these applications is incorporated herein by reference.

### BACKGROUND OF THE INVENTION

### Technical Field

The present invention relates to a fluidic device and a method for manufacturing a fluidic device.

### Description of Related Art

In recent years, the development, and the like, of Micro-Total Analysis Systems (μ-TASs) aimed at speeding up, improving efficiency, and integrating tests in the field of in vitro diagnostics, or aimed at miniaturizing test equipment, have been attracting attention, and active research is being conducted worldwide.

A μ-TAS is superior to conventional inspection equipment in that, for example, it allows for measurement and analysis to be performed with a small amount of sample, is portable, and is disposable at low cost.

In addition, it is attracting attention as a highly useful method when using expensive reagents or testing small quantities of multiple specimens.

A device with a flow channel and a pump placed on the channel has been reported as a component of a μ-TAS (Jong Wook Hong, Vincent Studer, Giao Hang, W French Anderson, and Stephen R Quake, Nature Biotechnology 22, 435-439 (2004)). In such a device, multiple solutions are mixed in the channel by injecting multiple solutions into the channel and operating the pump.

### BRIEF DESCRIPTION OF THE DRAWINGS

FIG. 1 is a perspective view of a fluidic device according to an embodiment.

FIG. 2 is an enlarged view of the section through A-A shown in FIG. 1.

FIG. 3 is a flowchart showing a method for manufacturing a fluidic device according to an embodiment.

FIG. 4 is a schematic diagram showing a method for manufacturing a fluidic device according to an embodiment.

FIG. 5 is a schematic diagram showing a method for manufacturing a fluidic device according to an embodiment.

FIG. 6 is a perspective view of a fluidic device according to a first variation.

FIG. 7 is an enlarged view of the section through B-B shown in FIG. 6.

FIGS. 8A, 8B, and 8C are cross-sectional views showing a method for manufacturing the fluidic device of the first variation.

FIGS. 9A and 9B are cross-sectional views showing a method for manufacturing a fluidic device according to a second variation.

FIGS. 10A and 10B are schematic diagrams of a fluidic device according to a third variation.

FIGS. 11A and 11B are schematic diagrams of a fluidic device according to a fourth variation.

FIGS. 12A and 12B are schematic diagrams of a fluidic device according to a fifth variation.

FIGS. 13A and 13B are schematic diagrams of a fluidic device according to a sixth variation.

FIG. 14 is a cross-sectional view of a fluidic device consisting of three layers.

FIG. 15 is a cross-sectional view of a fluidic device according to a seventh variation.

FIG. 16 is a cross-sectional view of a fluidic device according to an eighth variation.

FIGS. 17A, 17B, 17C, and 17D are cross-sectional views of a fluidic device according to a ninth variation.

### DETAILED DESCRIPTION OF THE INVENTION

Hereinafter, a fluidic device and a method for manufacturing a fluidic device, according to embodiments of the present invention will be described with reference to the drawings. It should be noted that the present invention is not limited by the following embodiments. In the description of each drawing, the same parts are denoted by the same reference numbers.

The drawings referred to in the following description merely represent, in a schematic manner, the shape, size, and positional relationship, to the extent that the content of the present invention may be understood. In other words, the present invention is not limited only to the shapes, sizes, and positional relationships illustrated in the respective figures. In addition, the drawings may also include, among the same, parts having different dimensional relationships and ratios from each other.

### (Configuration of Fluidic Device)

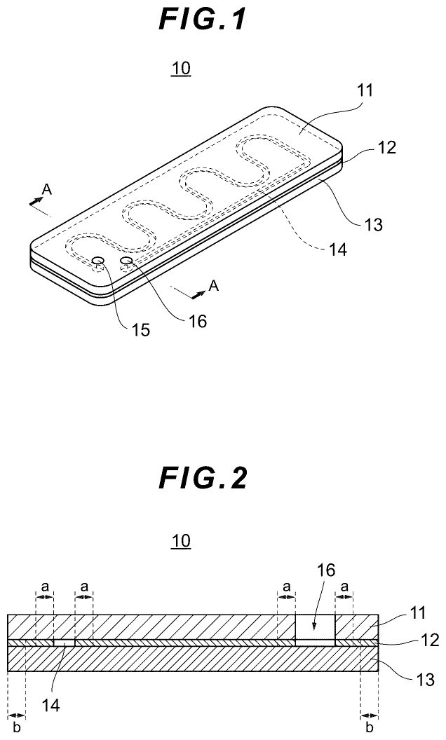

FIG. 1 is a perspective view of a fluidic device according to an embodiment. FIG. 2 is an enlarged view of the section through A-A shown in FIG. 1.

An example of the fluidic device 10 of the present embodiment includes a device for detecting a sample substance contained in a specimen sample by means of an immune reaction, an enzyme reaction, and a similar reaction. Examples of the sample substance to be detected include biomolecules such as nucleic acids, DNAs, RNAs, peptides, proteins, and extracellular endoplasmic reticula. In the fluidic device 10, the liquid containing the specimen sample is circulated and mixed with a predetermined reagent to cause a reaction. However, the use of the fluidic device 10 according to the present embodiment is not limited to the above.

As shown in FIGS. 1 and 2, the fluidic device 10 comprises a first substrate 11, an intermediate layer 12, and a second substrate 13. In the orientation shown in FIG. 2, the intermediate layer 12 is stacked on the second substrate 13, and the first substrate 11 is stacked on the intermediate layer 12. The respective layers of the first substrate 11, the intermediate layer 12, and the second substrate 13 are bonded with adjacent layer(s) by means of laser welding.

The first substrate 11 and the second substrate 13 are rigid substrates both made from resin material that is of the same type. The first substrate 11 and the second substrate 13 are made from a material that is transmissive to laser light.

The intermediate layer 12 is made from resin material that is of the same type as the first substrate 11 and the second substrate 13, and is absorptive to laser light. A flow channel 14 is formed in the intermediate layer 12 that penetrates the intermediate layer 12 in the thickness direction. It should be noted that the pattern of the flow channel 14 is not limited to the pattern shown in FIG. 1, and it may be designed appropriately according to the application, and the like, of the fluidic device 10.

Through-holes 15 and 16 are formed in the first substrate 11, which are in communication with the flow channel 14. These through-holes 15 and 16 may be used as injection holes for injecting the liquid containing the specimen into the channel 14 and/or as discharge holes for discharging the liquid from the channel 14. Of course, the location and shape of the through-holes 15 and 16 are not limited to those shown in FIG. 1, and they may be formed according to the application, and the like, of the fluidic device 10. In addition, either or both of the through-holes 15, 16 may be provided in the second substrate 13.

In addition, a valve or valve pump may be formed by further forming a through-hole in communication with the flow channel 14 on the first substrate 11 or the second substrate 13, and placing a diaphragm member made from elastic material, such as rubber or elastomer resin, in this through-hole. Alternatively, one or more through-holes may further be provided in the first substrate 11 or the second substrate 13 for injecting the reagent into the channel 14.

In addition, a recess may be made in a part of the surface of the first substrate 11 or the second substrate 13 on the intermediate layer 12 side, and a processing substrate that causes a predetermined reaction by drawing the liquid circulating through the flow channel 14 may be placed in this recess. For example, a DNA array chip, an electric field sensor, a heating heater, an element that performs chromatography, and the like, may be provided in the processing substrate.

Next, the materials that form the first substrate 11, the intermediate layer 12, and the second substrate 13 will be described in detail. The first substrate 11, the intermediate layer 12, and the second substrate 13 are all made from resin material that is of the same type. In detail, a thermoplastic resin material that can be bonded by laser welding is used as the material for these substrates. Examples of the material that can be used for the first substrate 11, the intermediate layer 12, and the second substrate 13 include: a general-purpose resin of a crystalline resin (polypropylene (PP), polyvinyl chloride (PVC), etc.), engineering plastic (polyethylene terephthalate (PET), cycloolefin polymer (COP), cycloolefin copolymer (COC), etc.), super engineering plastic (polyphenylene sulfide (PPS), polyetheretherketone (PEEK), etc.); a general-purpose resin of a non-crystalline resin (acrylonitrile butadiene styrene copolymer synthetic resin (ABS), polymethylmethacrylate (PMMA), etc.), engineering plastic (polycarbonate (PC), polyphenylene ether (PPE), etc.), super engineering plastic (polyethersulfone (PES), etc.), polymethylpentene (PMP); and similar resins.

As mentioned above, the first substrate 11 and the second substrate 13 are made from resin material that is transmissive to laser light, and the intermediate layer 12 is made from resin material that is absorptive to the laser light. In other words, the absorptivity of the intermediate layer 12 to the laser light is higher than the absorptivity of the first substrate 11 and the second substrate 13 to the laser light. Although the wavelength band of the laser light that can be used in the method for manufacturing fluidic devices, which will be described later, is not particularly limited, laser light in the visible to infrared light range may be used in terms of versatility, cost, and the like. A specific example may be laser light with wavelengths ranging, for example, from 800 nm to 1100 nm. Preferably, the first substrate 11 and the second substrate 13 have a transmissivity of approximately 20% or more to such laser light. The thickness of the first substrate 11 and the second substrate 13 is determined so that the laser light transmitted through the first substrate 11 or the second substrate 13 can sufficiently reach the intermediate layer 12, depending on the type of resin material, additives, etc.

The intermediate layer 12 is made from a material that is colored by adding carbon black or other pigments to a resin that is of the same type as the first substrate 11 and the second substrate 13. The thickness of the intermediate layer 12 may be such that the intermediate layer 12 is heated and melts over the entire thickness direction by the laser light reaching the intermediate layer 12 through the first substrate 11 or the second substrate 13. As an example, in the case of an intermediate layer 12 made from polycarbonate, the thickness may be around 0.01 mm to 0.25 mm. If the thickness is larger than 0.25 mm, it becomes difficult to melt the intermediate layer 12 over the entire thickness direction by laser light irradiation, and it becomes difficult to weld the intermediate layer 12 with the substrate, which is on the opposite side to the first substrate 11 or the second substrate 13, into which the laser light is injected (described later). On the other hand, if the thickness is less than 0.01 mm, the height of the flow channel 14 in the fluidic device 10 may be too small, and therefore there may be a risk that it becomes difficult to circulate the liquid.

### (Method for Manufacturing a Fluidic Device)

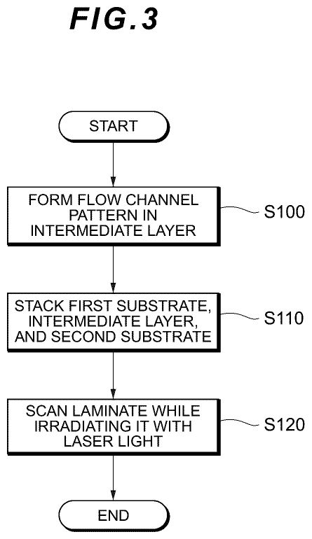

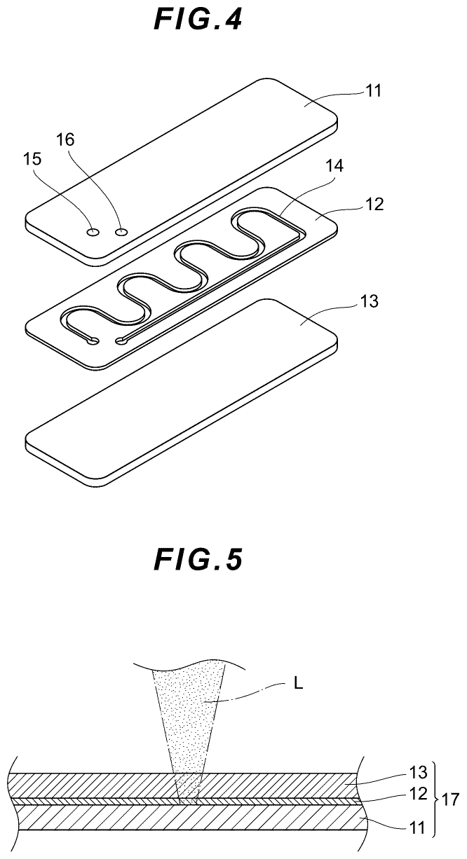

FIG. 3 is a flowchart showing a method for manufacturing a fluidic device according to an embodiment. FIGS. 4 and 5 are schematic diagrams showing a method for manufacturing a fluidic device according to an embodiment.

First, resin substrates to be used as the first substrate 11, the intermediate layer 12, and the second substrate 13 are prepared in advance. In addition, through-holes to be used as injection and discharge holes for liquid, and through-holes for placing diaphragm members, etc., are formed in the resin substrate to be used as the first substrate 11 or the second substrate 13 in advance as necessary.

At step S100, a flow channel pattern is formed in the intermediate layer. In other words, a portion that will serve as the flow channel 14 is hollowed out from the resin substrate to be used as the intermediate layer 12 (see the intermediate layer 12 in FIG. 4). The manner in which the flow channel pattern is formed is not particularly limited, and die cutting may be performed with a punch, or a knife may be used to hollow out the pattern.

In the subsequent step S110, the first substrate 11, the intermediate layer 12, and the second substrate 13 are stacked as shown in FIG. 4. At this time, preferably, pressure-tight adhesion is applied to a laminate 17 consisting of the first substrate 11, the intermediate layer 12, and the second substrate 13 by using a jig, or a similar tool.

In the subsequent step S120, the laminate 17 is scanned while being irradiated with laser light L, as shown in FIG. 5. It should be noted that the irradiation conditions of the laser light, such as the output of the laser light, are appropriately set according to the material, thickness, and the like, of the intermediate layer 12.

As a result, the intermediate layer 12 absorbs the laser light L and generates heat in the area irradiated with the laser light L, and melts over the entire thickness direction. As such, the contact surfaces of the first substrate 11 and the second substrate 13, which are in contact with the heated and melted intermediate layer 12, also melt. Thereafter, when the area irradiated with the laser light L moves, the melted resin material solidifies, and the first substrate 11 and the intermediate layer 12, and the intermediate layer 12 and the second substrate 13, are respectively welded together in a simultaneous manner, thereby bonding the first substrate 11, the intermediate layer 12, and the second substrate 13. It should be noted that being “welded together in a simultaneous manner” is not limited to welding the first substrate 11, the intermediate layer 12, and the second substrate 13 together in a simultaneous manner in terms of the time axis, and it may be considered that the first substrate 11, the intermediate layer 12, and the second substrate 13 are welded together in a simultaneous manner if the resin material melted due to the irradiation of the laser light L solidifies and each of the first substrate 11, the intermediate layer 12, and the second substrate 13 is welded, within the time period in which the area irradiated with the laser light L moves.

It should be noted that the manner in which the laser light L is scanned is not particularly limited. For example, the laminate 17 may be placed on a fixed stage and the irradiation direction of the laser light L may be changed by a galvanoscanner. Alternatively, the irradiation direction of the laser light L may be fixed, and the laminate may be placed on a movable stage. Then, by moving the movable stage, the area of the laminate 17 irradiated with the laser light L may be relatively moved. In FIG. 5, the laminate 17 is irradiated with the laser light L from the direction of the second substrate 13, but the laser light L may be irradiated from the direction of the first substrate 11.

In this way, when the laser light irradiation to the predetermined area of the laminate 17 is completed, the fluidic device 10 as shown in FIG. 1 is obtained.

Here, preferably, the area of the intermediate layer 12 that is to be laser welded with the first substrate 11 and the second substrate 13 includes at least the area around the flow channel 14 (see the areas marked as “a” in FIG. 2). This improves the sealing property of the flow channel 14 and prevents the leakage of liquid into the interface between the first substrate 11 and the intermediate layer 12 and the interface between the intermediate layer 12 and the second substrate 13. The area that is to be laser welded may also include the periphery of the fluidic device 10 (see the areas marked as “b” in FIG. 2). This prevents the entry of impurities from the outside into the interface between the first substrate 11 and the intermediate layer 12 and the interface between the intermediate layer 12 and the second substrate 13. Further, the area that is to be laser welded may be the entire surface of the intermediate layer 12. This allows the first substrate 11, the intermediate layer 12, and the second substrate 13 to be firmly bonded to each other.

In the present embodiment, a flow channel is formed in the intermediate layer 12, but it may instead be formed in the contact surface of the first substrate 11 or the second substrate 13 with the intermediate layer 12. In this case, a flow channel may be formed by methods such as cutting the surface of the sheet material that will serve as the first substrate 11 or the second substrate 13, or forming a substrate with a flow channel pattern by injection molding.

For example, in the contact surface of at least one of the first substrate 11 or the second substrate 13 with the intermediate layer 12, an exposed flow channel may be formed, and a penetration area may be formed in the intermediate layer 12 that penetrates in the stacking direction at the location where it connects to the flow channel in the first substrate 11 or the second substrate 13. In this case, by irradiating the areas other than the penetration area with the laser light L, the areas irradiated with the laser light L in the intermediate layer 12 melt, and the first substrate 11, the intermediate layer 12, and the second substrate 13 are then bonded in such irradiated areas.

As described above, according to the above embodiment, a laminate is formed, which is obtained by placing, between two substrates (the first substrate 11, the second substrate 13, etc.) that are of the same type and are transmissive to laser light, an intermediate layer 12 made from resin material that is of the same type as the substrates and is absorptive to laser light, and by irradiating the laminate with laser light, the intermediate layer melts over the entire thickness direction in the area irradiated with the laser light, whereby the intermediate layer is welded to the two substrates in a simultaneous manner.

Here, in the general laser welding method, a resin material that is transmissive to laser light (a transparent resin substrate) and a resin material that is absorptive to laser light (colored resin substrate) are stacked, and laser light is applied from the direction of the transparent resin substrate, whereby the interface between the transparent resin substrate and the colored resin substrate melts and both the substrates are welded. For that reason, only a two-layer structure can be formed by a single laser light irradiation process. Accordingly, it is necessary to first form a two-layer structure by using the method described above, then stack another transparent resin substrate on the colored resin substrate of the two-layer structure, and then reapply laser light from the direction of this other transparent resin substrate to perform welding, in order to form a three-layer structure.

In this regard, according to the above embodiment, a structure (fluidic device) consisting of three layers of resin material can be formed by a single laser light irradiation process, thereby making it possible to reduce man-hours as compared to conventional methods.

### (First Variation)

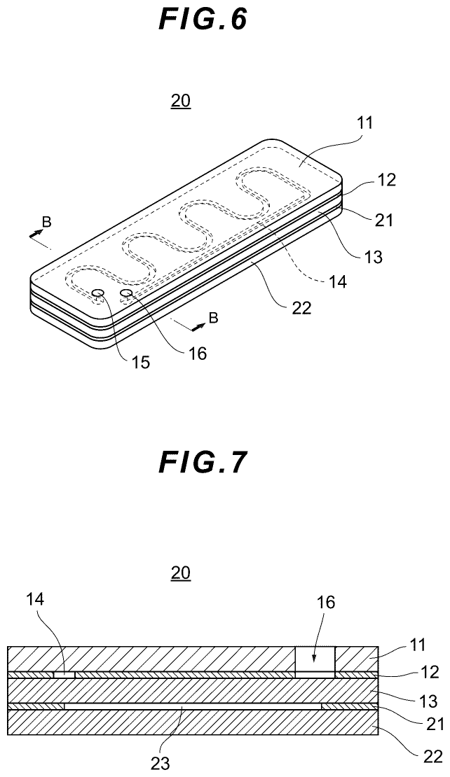

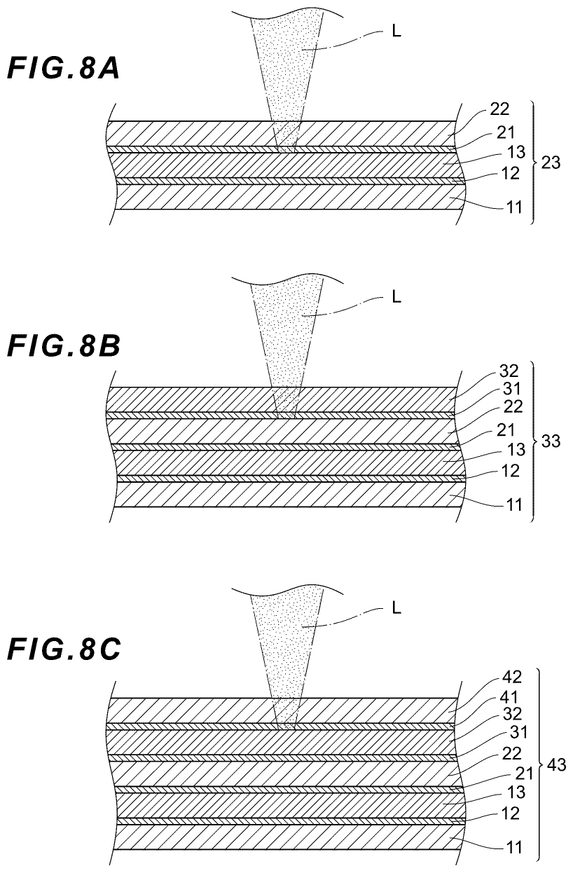

FIG. 6 is a perspective view of a fluidic device according to a first variation. FIG. 7 is an enlarged view of the section through B-B shown in FIG. 6. FIGS. 8A through 8C are cross-sectional views showing a method for manufacturing the fluidic device of the first variation.

As shown in FIGS. 6 and 7, the fluidic device 20 according to the first variation further comprises a second intermediate layer 21 and a third substrate 22 in addition to the first substrate 11, the intermediate layer 12, and the second substrate 13. The respective layers of the second intermediate layer 21 and the third substrate 22 are bonded with adjacent layer(s) by means of laser welding.

As with the intermediate layer 12, the second intermediate layer 21 is made from resin material that is of the same type as the second substrate 13 and is absorptive to laser light. In the second intermediate layer 21, a flow channel 23 may also be formed that penetrates the second intermediate layer 21 in the thickness direction. Alternatively, a flow channel may be formed in the contact surface of the second substrate 13 or the third substrate 22 with the second intermediate layer 21. In addition, a through-hole may be formed in the second substrate 13 for communicating the flow channel in the intermediate layer 12 with the flow channel 23 in the second intermediate layer 21 (or with the flow channel formed in the second substrate 13 or the third substrate 22).

The third substrate 22 is a rigid substrate made from a material that is of the same type as the second substrate 13 and is transmissive to laser light. As with the first substrate 11 or the second substrate 13, through-holes for injecting or discharging liquid, recesses for placing processing substrates, through-holes for placing diaphragm members, and/or the like, may also be formed in the third substrate 22.

Such fluidic device 20 can be manufactured as follows:

As shown in FIG. 8A, the second intermediate layer 21 that is formed with a flow channel pattern as appropriate is stacked on the second substrate 13, and then the third substrate 22 is stacked thereon. Then, the laminate 23 is irradiated with laser light L from the direction of the third substrate 22 toward the second intermediate layer 21. As a result, the second intermediate layer 21 absorbs the laser light and generates heat in the area irradiated with the laser light L, and melts over the entire thickness direction. Therefore, the second substrate 13 and the second intermediate layer 21, and the second intermediate layer 21 and the third substrate 22, are respectively bonded together in a simultaneous manner (see step S120 in FIG. 3). In this way, when the laser light irradiation to the predetermined area of the laminate 23 is completed, the five-layer fluidic device 20 is obtained in which the first substrate 11, the intermediate layer 12, the second substrate 13, the second intermediate layer 21, and the third substrate 33 are integrated.

It should be noted that in FIG. 8A, the second intermediate layer 21 and the third substrate 22 are stacked on the second substrate 13 side, but the second intermediate layer 21 and the third substrate 22 may instead be stacked on the first substrate 11 side.

In the first variation, it is also possible to manufacture a multi-stage structure (multi-stage fluidic device) with a further layer(s) stacked on the five-layer structure shown in FIG. 8A. More specifically, as shown in FIG. 8B, a third intermediate layer 31, which is made from resin material that is of the same type as the third substrate 22 and is absorptive to laser light, and formed with a flow channel pattern as appropriate, is stacked on the third substrate 22, and then a fourth substrate 32 is stacked thereon, which is made from resin material that is of the same type as the third substrate 22 and is transmissive to laser light. It should be noted that the third intermediate layer 31 and the fourth substrate 32 may instead be stacked on the first substrate 11 side.

The laminate 33 as shown in FIG. 8B is then irradiated with laser light L from the direction of the fourth substrate 32 toward the third intermediate layer 31. As a result, the third intermediate layer 31 melts over the entire thickness direction in the area irradiated with the laser light L, and bonds to each of the third substrate 22 and the fourth substrate 32 in a simultaneous manner. In this way, the seven-layer structure is obtained.

Further, as shown in FIG. 8C, a fourth intermediate layer 41, which is made from resin material that is of the same type as the fourth substrate 32 and is absorptive to laser light, and formed with a flow channel pattern as appropriate, is stacked on the fourth substrate 32, and then a fifth substrate 42 is stacked thereon, which is made from resin material that is of the same type as the fourth substrate 32 and is transmissive to laser light. It should be noted that the fourth intermediate layer 41 and the fifth substrate 42 may instead be stacked on the first substrate 11 side.

The laminate 43 as shown in FIG. 8C is then irradiated with laser light L from the direction of the fifth substrate 42 toward the fourth intermediate layer 41. As a result, the fourth intermediate layer 41 melts over the entire thickness direction in the area irradiated with the laser light L, and bonds to each of the fourth substrate 32 and the fifth substrate 42 in a simultaneous manner. In this way, the nine-layer structure is obtained.

According to the first variation, by further stacking an additional intermediate layer and an additional substrate on the structure consisting of multiple layers of resin material and irradiating the additional intermediate layer with laser light via the additional substrate, the additional intermediate layer and the additional substrate can be welded to the original structure in a simultaneous manner. In short, each additional laser light irradiation process allows the number of layers in the structure to increase by two, thereby making it possible to easily form multi-stage structures (fluidic devices).

In the general laser welding method, it is only possible to form a structure of three layers consisting of a colored resin substrate and transparent resin substrates placed on both sides of the colored resin substrate. In order to increase the number of layers, it may be possible to apply a laser light absorptive material to the surface (transparent resin substrate) of the three-layer structure, and then stack a transparent resin substrate and perform laser welding. However, when applying such a structure to a fluidic device, the elution of impurities into the flow channel is a concern.

In this regard, according to the first variation, each additional laser light irradiation process allows the number of layers to increase by two, thereby making it possible to increase the number of layers without an upper limit. In addition, since the substrate and the intermediate layer can be bonded without any substance interposed between the two, defects such as the elution of impurities into the flow channel in fluidic devices can be prevented.

In the first variation, an example is described in which two substrates are bonded through an intermediate layer in each laser light irradiation process, but it is also possible to bond three or more substrates (i.e., a multilayer substrate) in a single laser light irradiation process. The following describes fluidic devices according to the second to fifth variations manufactured by bonding a multilayer substrate in a single laser irradiation process.

### (Second Variation)

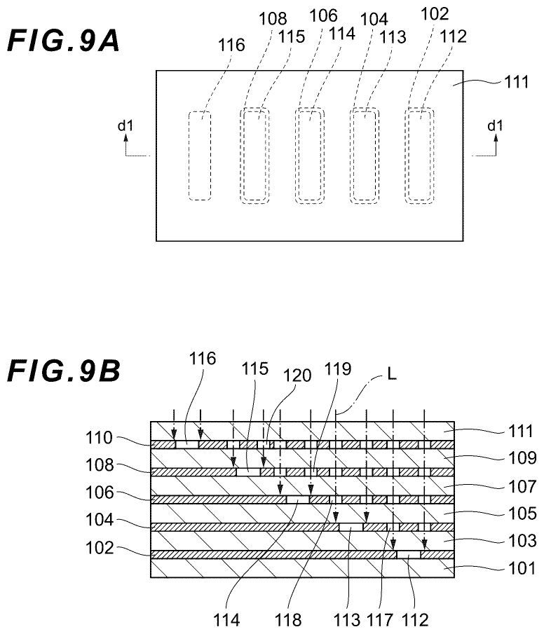

FIGS. 9A and 9B are schematic diagrams of a fluidic device according to a second variation. FIG. 9A shows a top surface of the fluidic device and FIG. 9B shows a cross-section through d1-d1 in FIG. 9A.

The fluidic device 100 shown in FIGS. 9A and 9B comprises: substrates 101, 103, 105, 107, 109, 111 made from resin material that is transmissive to laser light L; and intermediate layers 102, 104, 106, 108, 110 made from resin material that is of the same type as the substrates and is absorptive to laser light L. These substrates and intermediate layers are stacked in an alternating manner. The conditions of the materials and thickness of the substrates 101, 103, 105, 107, 109, 111 and the intermediate layers 102, 104, 106, 108, 110 are the same as those in the above embodiment and the first variation.

In the intermediate layers 102, 104, 106, 108, 110, flow channels 112, 113, 114, 115, 116 are respectively formed that penetrate the intermediate layers in the thickness direction.

In the intermediate layer 104, a through-hole 117 is formed for passing the laser light L that enters from the direction of the upper layer into the area around the flow channel 112 of the underlying intermediate layer 102. In the intermediate layer 106, a through-hole 118 is formed for passing the laser light L that enters from the direction of the upper layer into the areas around the flow channels 112, 113 of the underlying intermediate layers 102, 104. Similarly, in the intermediate layer 108, a through-hole 119 is formed so as to cause the laser light L to enter into the areas around the flow channels 112, 113, 114 of the underlying intermediate layers 102, 104, 106. In the intermediate layer 110, a through-hole 120 is formed so as to cause the laser light L to enter into the areas around the flow channels 112, 113, 114, 115 of the underlying intermediate layers 102, 104, 106, 108.

When the structure in which the substrates 101, 103, 105, 107, 109, 111 and the intermediate layers 102, 104, 106, 108, 110 are stacked is irradiated with laser light L from the direction of the substrate 111, the intermediate layer 110 melts by way of the laser light L transmitted through the substrate 111, and the substrate 111, the intermediate layer 110, and the substrate 109 are bonded. The laser light L that has transmitted through the substrates 111, 109 and passed through the through-hole 120 enters the area around the flow channel 115 of the intermediate layer 108, thereby melting such area and bonding the substrate 109, the intermediate layer 108, and the substrate 107 in this area. The laser light L that has transmitted through the substrates 111, 109, 107 and passed through the through-holes 120, 119 enters the area around the flow channel 114 of the intermediate layer 106, thereby melting such area and bonding the substrate 107, the intermediate layer 106, and the substrate 105 in this area. The same applies to the intermediate layers 104, 102. The laser light L that has transmitted through the upper layer substrates and passed through the through-holes formed in the upper layer intermediate layers is applied to the areas around the flow channels 113, 112, thereby bonding each intermediate layer 104, 102 and the substrates sandwiching such intermediate layer. In this way, by irradiating a part of an intermediate layer with laser light L, the substrate below such intermediate layer and the substrate above such intermediate layer may be bonded.

According to the second variation, by forming a through-hole in an intermediate layer for passing laser light L therethrough, the laser light L can reach a second or further lower intermediate layer when viewed from the direction of the irradiation. Accordingly, multiple substrates can be bonded in a single laser light irradiation process.

### (Third Variation)

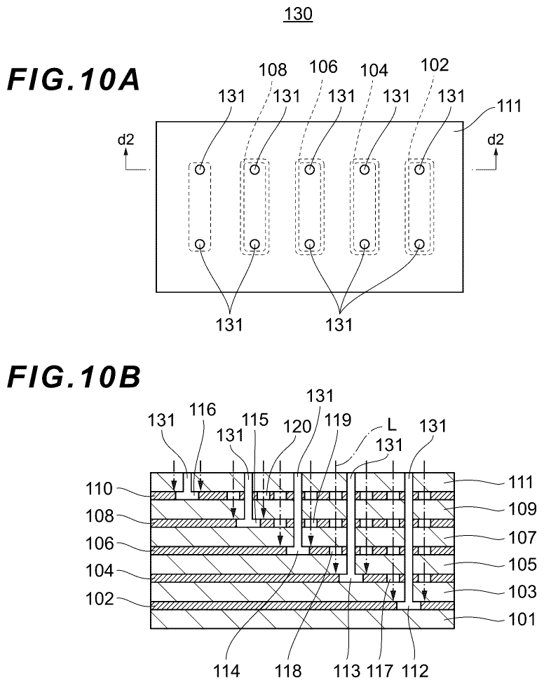

FIGS. 10A and 10B are schematic diagrams of a fluidic device according to a third variation. FIG. 10A shows a top surface of the fluidic device and FIG. 10B shows a cross-section through d2-d2 in FIG. 10A.

The fluidic device 130 shown in FIGS. 10A and 10B is obtained by further providing the fluidic device 100 shown in FIGS. 9A and 9B with openings 131. The openings 313 communicate from the surface of the fluidic device 130 (the top surface of the substrate 111) to the flow channels 112, 113, 114, 115, 116 respectively formed in the intermediate layers 102, 104, 106, 108, 110. Each opening 131 may be provided by pre-forming a through-hole at the relevant locations in each substrate 103, 105, 107, 109, 111 and each intermediate layer 104, 106, 108, 110.

By forming such openings 131, the liquid can be circulated between different layers. In short, a fluidic device 130 with a complex multi-layer structure capable of circulating liquid between layers can be easily manufactured according to the third variation.

### (Fourth Variation)

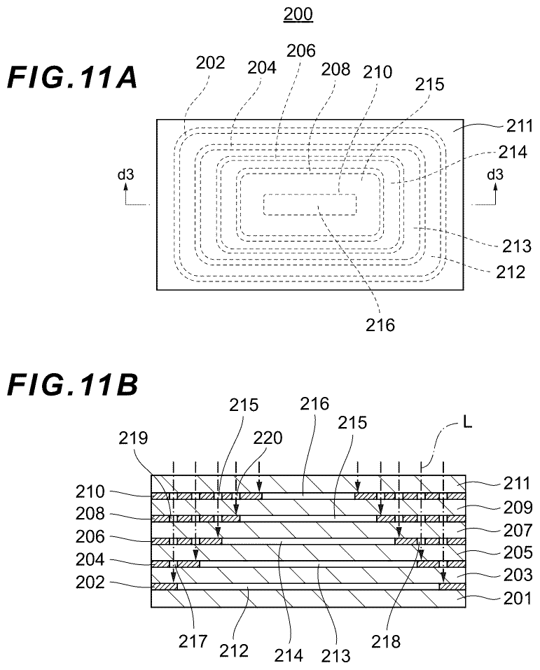

FIGS. 11A and 11B are schematic diagrams of a fluidic device according to a fourth variation. FIG. 11A shows a top surface of the fluidic device and FIG. 11B shows a cross-section through d3-d3 in FIG. 11A. The fluidic device 200 shown in FIGS. 11A and 11B is obtained by varying the flow channel pattern formed in the respective intermediate layers in a device where a multilayer substrate is bonded by a single laser light irradiation process as in the fluidic device 100 shown in FIGS. 9A and 9B.

The fluidic device 200 comprises: substrates 201, 203, 205, 207, 209, 211 made from resin material that is transmissive to laser light L; and intermediate layers 202, 204, 206, 208, 210 stacked in an alternating manner with these substrates and made from resin material that is absorptive to laser light L. In the intermediate layers 202, 204, 206, 208, 210, flow channels 212, 213, 214, 215, 216 are respectively formed that penetrate the intermediate layers in the thickness direction. In addition, in the intermediate layers 204, 206, 208, 210, through-holes 217, 218, 219, 220 are formed for passing the laser light L that enters from the direction of the upper layer into the areas around the flow channels of the underlying intermediate layers 202, 204, 206, 208.

When the structure in which the substrates 201, 203, 205, 207, 209, 211 and the intermediate layers 202, 204, 206, 208, 210 are stacked is irradiated with laser light L from the direction of the substrate 201, the laser light L that has transmitted through the upper layer substrates and passed through the through-holes formed in the upper layer intermediate layers is applied to the areas around the flow channels 212, 213, 214, 215, 216, thereby bonding each intermediate layer and the substrates sandwiching such intermediate layer.

In this way, even in the case of manufacturing a fluidic device 200 having wide-shaped flow channels 212, 213, 214, 215, 216 as shown in FIGS. 11A and 11B, it can be easily manufactured according to the fourth variation.

### (Fifth Variation)

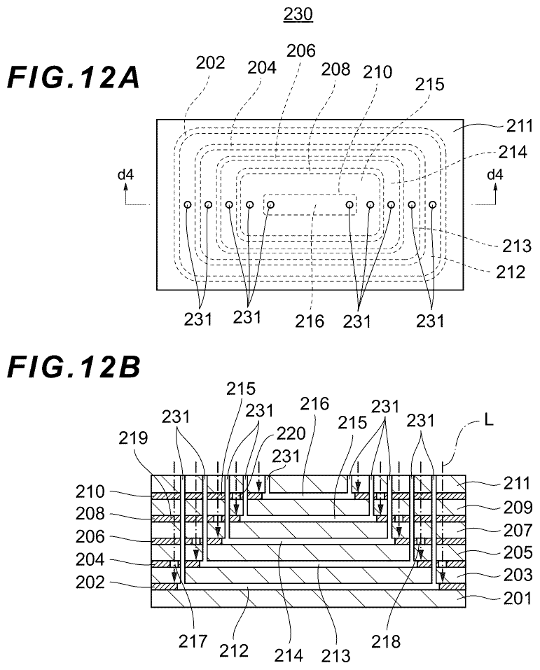

FIGS. 12A and 12B are schematic diagrams of a fluidic device according to a fifth variation. FIG. 12A shows a top surface of the fluidic device and FIG. 12B shows a cross-section through d4-d4 in FIG. 12A.

The fluidic device 230 shown in FIGS. 12A and 12B is obtained by further providing the fluidic device 200 shown in FIGS. 11A and 11B with openings 231. The openings 231 communicate from the surface of the fluidic device 230 (the top surface of the substrate 211) to the flow channels 212, 213, 214, 215, 216 respectively formed in the intermediate layers 202, 204, 206, 208, 210. Each opening 231 may be provided by pre-forming a through-hole at the relevant locations in each substrate 203, 205, 207, 209, 211 and each intermediate layer 204, 206, 208, 210.

### (Sixth Variation)

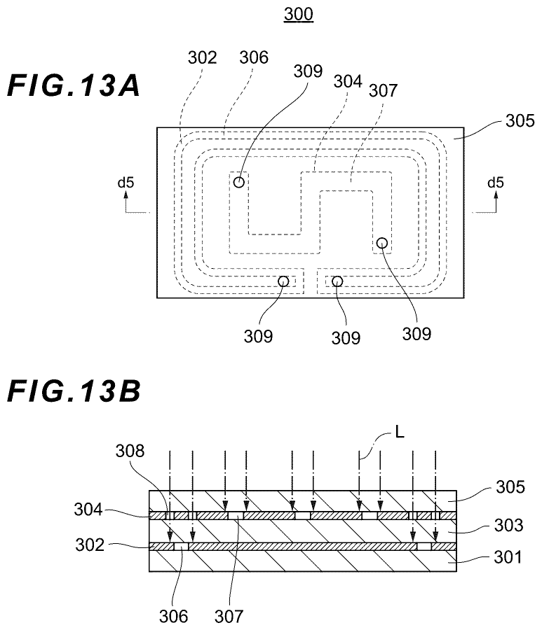

FIGS. 13A and 13B are schematic diagrams of a fluidic device according to a sixth variation. FIG. 13A shows a top surface of the fluidic device and FIG. 13B shows a cross-section through d5-d5 in FIG. 13A. The fluidic device 300 shown in FIGS. 13A and 13B is obtained by varying the flow channel pattern formed in the respective intermediate layers in the fluidic device 100 shown in FIGS. 9A and 9B.

The fluidic device 300 comprises substrates 301, 303, 305 and intermediate layers 302, 304 stacked in an alternating manner with these substrates. In the intermediate layers 302, 304, flow channels 306, 307 are respectively formed that penetrate the intermediate layers in the thickness direction. In addition, in the intermediate layer 304, a through-hole 308 is formed for passing the laser light L that enters from the direction of the upper layer into the area around the flow channel 306 of the underlying intermediate layer 302. In addition, openings 309 may further be provided that communicate from the surface of the fluidic device 300 (the top surface of the substrate 305) to the flow channels 306, 307 respectively formed in the intermediate layers 302, 304.

As described above, according to the above embodiment and the first to six variations, since laser welding is performed by placing an intermediate layer that is pre-formed with a flow channel pattern between two substrates, a fluidic device with a fine flow channel pattern formed therein can be fabricated easily and at low cost. In addition, since a low-profile and uniform flow channel can be formed, a trace amount of a liquid sample can be circulated in a smooth manner in the fluidic device.

In addition, according to the above embodiment and the first to sixth variations, since the substrate and the intermediate layer are made from resin material that is of the same type, easy and firm bonding can be realized by laser welding without the need for pretreatment, or similar treatment, and it is possible to form a flow channel which is a leak-free closed space.

Conventionally, fluidic devices with flow channels formed therein have been manufactured by forming recesses that serve as flow channels in the surface of a thick substrate, and then bonding a separate substrate to this surface. However, in the case of forming the recess in the substrate surface by cutting, a lot of work and time is required, and advanced technology to form fine patterns is required. In addition, in the case of manufacturing a substrate formed with a recess by injection molding, significant cost is needed to make the mold.

In contrast, according to the above embodiment and the first to sixth variations, even with a fine flow channel pattern, the flow channel can be easily formed in the intermediate layer by means such as die cutting. Accordingly, the work, time, and even the costs of manufacturing fluidic devices can be reduced.

In addition, according to the above embodiment and the first and sixth variations, all substrates and intermediate layers are made from resin material that is of the same type; namely, resin material with the same thermal expansion coefficient. As such, it is possible to suppress thermal stress caused by thermal expansion or shrinkage associated with laser welding in fluidic devices. Accordingly, it is possible to suppress the separation between the substrate and the intermediate layer, and improve the sealing property of the flow channel provided inside the fluidic device. In addition, since the top face, bottom face, and side faces of the flow channel are all made from resin material that is of the same type, it is possible to suppress the generation of thermal stress in the fluidic device even if a temperature change occurs in the liquid sample circulating through the flow channel. Further, if the top face, bottom face, and side faces of the flow channel are all made from resin material that is of the same type, there is an advantage to the effect that it is possible to apply a homogeneous treatment under the same treatment conditions when surface treatment is to be applied to the inner faces of the flow channel.

In the above embodiment and the first to sixth variations, a fluidic device is manufactured in which the substrate and the intermediate layer are bonded, through a single laser light irradiation process in which an intermediate layer that is absorptive to laser light is placed between the substrates that are transmissive to laser light, and the laminate consisting of these layer and substrates is irradiated with laser light. However, the bonding technique with a single laser light irradiation process may be applied when adding a further configuration to the fluidic device.

The following describes variations in which a further configuration is added to the fluidic device.

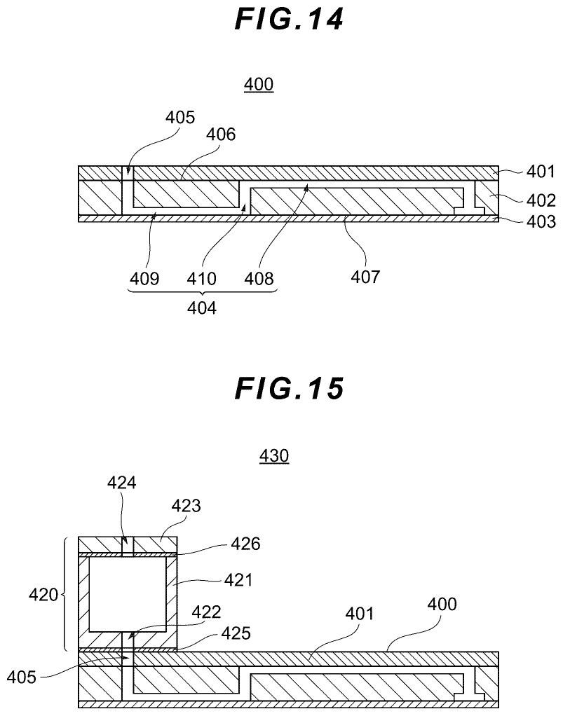

FIG. 14 is a cross-sectional view of a fluidic device consisting of three layers. The fluidic device 400 shown in FIG. 14 comprises: substrates 401, 403 made from resin material that is transmissive to laser light; and a substrate 402 placed between these substrates 401, 403 and made from resin material that is absorptive to laser light. A flow channel 404 with a three-dimensional structure is formed inside the fluidic device 400. In addition, an opening 405 communicating with the flow channel 404 is formed in the surface of the substrate 401 of the fluidic device 400.

As an example, such fluidic device 400 may be fabricated by: respectively forming recesses 408, 409, which will serve as the flow channel 404, on the main surfaces 406, 407 of the substrate 402; forming a through-hole 410 for allowing the recesses 408, 409 to communicate with each other; stacking the substrates 401, 402, 403; and bonding the substrates 401, 402, 403 by applying laser light from the direction of the substrate 401 to the boundary with the substrate 402 and applying laser light from the direction of the substrate 403 to the boundary with the substrate 402.

### (Seventh Variation)

FIG. 15 is a cross-sectional view of a fluidic device according to a seventh variation, and is obtained by attaching an extension liquid reservoir 420 to the fluidic device 400 shown in FIG. 14. The extension liquid reservoir 420 comprises a chamber body 421 with an opening 422 formed in the bottom face thereof and a lid section 423 with an opening 424 formed therein. The chamber body 421 and the lid section 423 are made from resin material that is transmissive to laser light.

Such extension liquid reservoir 420 may be attached to the fluidic device 400 as follows. First, the position of the opening 422 of the chamber body 421 is aligned with the position of the opening 405 of the fluidic device 400, and the chamber body 421 is placed on the fluidic device 400 with a welding film 425 interposed therebetween. The welding film 425 is made from resin material that is of the same type as the chamber body 421 and the substrate 401 and is absorptive to laser light, and the area corresponding to the opening 422 of the chamber body 421 is opened in advance. The fluidic device 400, the welding film 425, and the chamber body 421 are then bonded through welding by applying laser light from the direction of the chamber body 421 to the welding film 425. Next, the lid section 423 is placed on the upper end face of the chamber body 421 with a welding film 426 interposed therebetween. The welding film 426 is made from the same material as the welding film 425, and the area corresponding to the opening 424 of the lid section 423 is opened in advance. The chamber body 421, the welding film 426, and the lid section 423 are then bonded through welding by applying laser light from the direction of the lid section 423 to the welding film 426. As a result, the fluidic device 430 with an extension liquid reservoir is obtained.

In this way, by attaching the extension liquid reservoir 420 to the fluidic device 400, the usable fluid volume can be increased even more as compared to the case where the fluidic device 400 is used alone.

### (Eighth Variation)

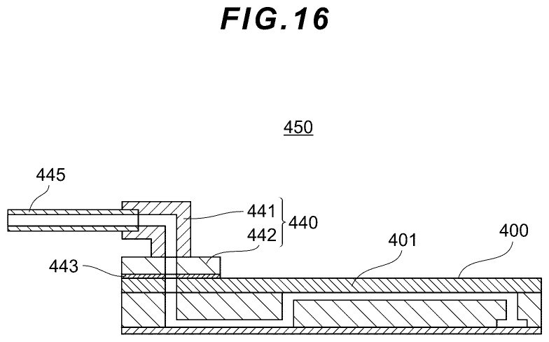

FIG. 16 is a cross-sectional view of a fluidic device according to an eighth variation, and is obtained by attaching an external intake port 440 to the fluidic device 400 shown in FIG. 14. The external intake port 440 comprises a port section 441, into which a pipe 445 connectable to external equipment is fitted, and a base 442 for supporting the port section 441. The base 442 is made from resin material that is transmissive to laser light, and a through-hole is provided at the location corresponding to a flow channel in the port section 441.

Such external intake port 440 may be attached to the fluidic device 400 as follows. First, the external intake port 440 is placed on the fluidic device 400 with a welding film 443 interposed therebetween and that is made from resin material that is absorptive to laser light. The area of the welding film 443 corresponding to the through-hole in the base 442 is opened in advance. The base 442, the welding film 443, and the substrate 401 of the fluidic device 400 are then bonded through welding by applying laser light from the direction of the base 442 to the welding film 443. As a result, the fluidic device 450 with an external intake port is obtained.

In this way, by attaching the external intake port 440, fluid can be taken into/out of the fluidic device 400 from/to other reagent reservoirs and the like. Depending on the shape of the port, the connection between the fluidic device and the port may become complicated, but even in such cases, a fluidic device with a fluid-leak-free port can be easily fabricated according to the eighth variation.

Now, the common fluidic device 400 has been shown in FIGS. 15 and 16. Standardizing the fluidic device 400 as the basic structure in this manner and attaching thereto an extension structure, such as the extension liquid reservoir 420 and/or the external intake port 440, allows the flow channel to be extended according to the applications.

### (Ninth Variation)

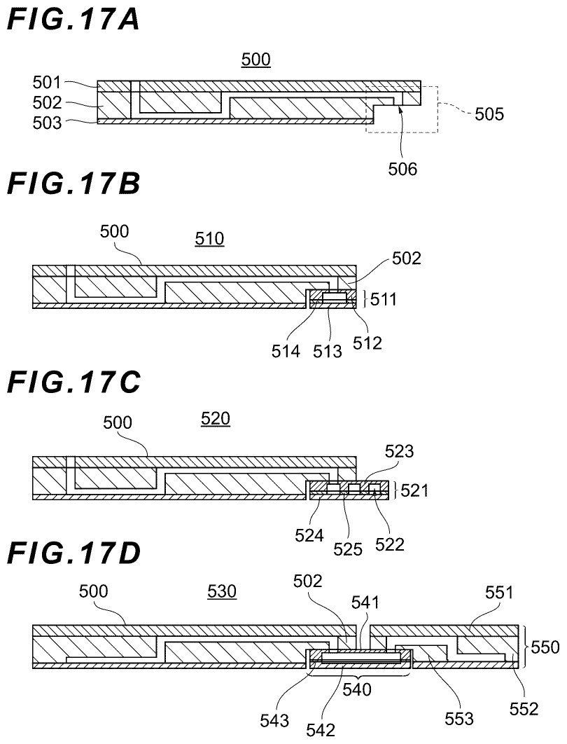

FIGS. 17A through 17C are cross-sectional views of a fluidic device according to a ninth variation.

The fluidic device 500 shown in FIG. 17A is obtained by providing the fluidic device 400 shown in FIG. 14 with an attaching section 505 for a detection chamber. In the attaching section 505, part of the substrate 502 and one end 506 of the flow channel formed inside the fluidic device 500 are exposed. The materials and basic structure of the substrates 501, 502, 503 provided in the fluidic device 500, and the method for bonding these substrates, are the same as those of the substrates 401, 402, 403 of the fluidic device 400.

The fluidic device 510 shown in FIG. 17B is obtained by attaching a detection chamber 511 to the fluidic device 500. The detection chamber 511 comprises a chamber top section 512 and a chamber bottom section 513, both made from resin material that is transmissive to laser light.

Such fluidic device 510 may be fabricated as follows. First, the chamber top section 512 is brought into contact with the attaching section 505 of the fluidic device 500, and laser light is applied from the direction of the chamber top section 512 toward the contact surface with the substrate 502, thereby welding the chamber top section 512 to the substrate 502. Next, the chamber bottom section 513 is stacked on the chamber top section 512 with a welding film 514 interposed therebetween, and laser light is applied from the direction of the chamber bottom section 513 toward the welding film 514, thereby welding the chamber top section 512, the welding film 514, and the chamber bottom section 513. As a result, the fluidic device 510 with a detection chamber is obtained.

In the case of bonding the detection chamber 511 to the fluidic device 500 through welding, it is possible to prevent incidents such as the elution of impurities in the detection chamber 511, since there is no need of adhesives or similar reagents.

The fluidic device 520 shown in FIG. 17C is obtained by attaching a detection chamber 521 with multiple reaction chambers 522 to the fluidic device 500. The detection chamber 521 comprises a chamber top section 523 and a chamber bottom section 524, both made from resin material that is transmissive to laser light. A welding film 525 is interposed between the chamber top section 523 and the chamber bottom section 524. The method for attaching such detection chamber 521 to the fluidic device 500 is similar to the method described above for the fluidic device 510.

By welding the detection chamber 521 to the fluidic device 500, the two can be bonded firmly. Accordingly, it is also possible to attach the detection chamber 521 so that part thereof protrudes from the end of the fluidic device 500.

The fluidic device 530 shown in FIG. 17D is obtained by connecting a separate fluidic device 550 to the fluidic device 500 via a coupling flow channel 540. The separate fluidic device 550 comprises substrates 551, 552, 553, as with the fluidic device 500. The materials and basic structure of these substrates 551, 552, 553, and the method for bonding these substrates, are the same as those of the substrates 501, 502, 503 of the fluidic device 500. In addition, an attaching port is also provided in the fluidic device 550, where part of the substrate 552 and one end of the flow channel formed inside the fluidic device 550 are exposed.

The coupling flow channel 540 comprises a flow channel top section 541 and a flow channel bottom section 542, both made from resin material that is transmissive to laser light.

Such fluidic device 530 may be fabricated as follows. First, the flow channel top section 541 is brought into contact with the attaching sections (i.e., the sections where part of the substrates 502, 552 is exposed) of the fluidic device 500 and the fluidic device 550, and laser light is applied from the direction of the flow channel top section 541 toward the contact surfaces with the substrates 502, 552, thereby welding the flow channel top section 541 to the substrate 502 and the substrate 552. Next, the flow channel bottom section 542 is stacked on the flow channel top section 541 with a welding film 543 interposed therebetween, and laser light is applied from the direction of the flow channel bottom section 542 toward the welding film 543, thereby welding the flow channel top section 541, the welding film 543, and the flow channel bottom section 542. As a result, the fluidic device 530 in which two fluidic devices 500, 550 are coupled with each other is obtained.

The present invention is not limited to the embodiment and variations described above, and may be carried out in various other forms within the scope that does not depart from the spirit of the present invention. For example, such various other forms may be formed by excluding some components from all of the components shown in the embodiment and variations, or by appropriately combining the components shown in the embodiment and variations.

Additional advantages and modifications will easily come to mind for those skilled in the art. Therefore, in a broader sense, the present invention is not limited to the specific details and representative embodiments shown and described herein. Accordingly, various modifications may be made without departing from the spirit or scope of the general concept of the present invention as defined by the accompanying claims and their equivalents.

1. A method for manufacturing a fluidic device, comprising the steps of:
forming a laminate including a first substrate made from resin material transmissive to laser light, an intermediate layer stacked on the first substrate and made from resin material absorptive to the laser light, and a second substrate stacked on the intermediate layer and made from resin material transmissive to the laser light; and
bonding the first substrate, the intermediate layer, and the second substrate by irradiating the laminate with the laser light from the direction of either the first substrate or the second substrate, melting the intermediate layer over the entire thickness direction in an area irradiated with the laser light, and welding the first substrate and the intermediate layer, and the intermediate and the second substrate,
wherein, the forming step includes at least either: forming a flow channel in a contact surface of at least either the first substrate or the second substrate with the intermediate layer; or forming a penetration area penetrating in the stacked direction in the intermediate layer.

2. The method for manufacturing a fluidic device according to claim 1, wherein the first substrate, the intermediate layer, and the second substrate are bonded in a simultaneous manner in the bonding step.

3. The method for manufacturing a fluidic device according to claim 1, wherein the bonding step includes irradiating an area around at least the flow channel of the intermediate layer with laser light.

4. The method for manufacturing a fluidic device according to claim 1, wherein the first substrate, the intermediate layer, and the second substrate are made from resin material of the same type as each other.

5. The method for manufacturing a fluidic device according to claim 1, wherein the thickness of the intermediate layer is between 0.01 mm and 0.25 mm, inclusive.

6. The method for manufacturing a fluidic device according to claim 1, further comprising the steps of:
forming a second laminate by further stacking, on either the first substrate side or the second substrate side of the laminate, a second intermediate layer made from resin material absorptive to the laser light and a third substrate made from resin material transmissive to the laser light; and
welding the second intermediate layer and the second substrate, and the second intermediate layer and the third substrate, by irradiating the second laminate with the laser light from the direction of the third substrate and melting the second intermediate layer over the entire thickness direction in an area irradiated with the laser light.

7. The method for manufacturing a fluidic device according to claim 6, wherein the second substrate, the second intermediate layer, and the third substrate are welded in a simultaneous manner.

8. The method for manufacturing a fluidic device according to claim 6, wherein the second intermediate layer and the third substrate are made from resin material of the same type as the second substrate.

9. A method for manufacturing a fluidic device, comprising the steps of:
forming a laminate having multiple substrates made from resin material transmissive to laser light and multiple intermediate layers made from resin material absorptive to the laser light stacked in an alternating manner such that layers at both ends serve as the substrates; and
bonding the laminate by irradiating the laminate with the laser light from the direction of either of the layers at both ends, melting the multiple intermediate layers in areas irradiated with the laser light, and welding the melted intermediate layer and two substrates making contact with the intermediate layer,
wherein the forming step includes at least either: forming a flow channel in a contact surface of at least any of the multiple substrates with the intermediate layer; or forming a penetration area penetrating in the stacked direction in at least any of the multiple intermediate layers.

10. The method for manufacturing a fluidic device according to claim 9, wherein the multiple substrates and the multiple intermediate layers are welded in a simultaneous manner.

11. The method for manufacturing a fluidic device according to claim 9, wherein
the forming step includes forming a penetration area penetrating in the stacked direction in at least any of the multiple intermediate layers, and
the laser light irradiated onto the laminate from the direction of either of the layers at both ends is capable of passing through the penetration areas.

12. A fluidic device, comprising:
a first substrate made from resin material transmissive to laser light;
a first intermediate layer stacked on the first substrate and being made from resin material absorptive to the laser light; and
a second substrate stacked on the intermediate layer and being made from resin material transmissive to the laser light,
wherein
at least one of the first substrate or the second substrate includes a flow channel formed in a contact surface with the intermediate layer,
the intermediate layer includes a penetration area penetrating in the stacked direction, and
the intermediate layer melts in an area irradiated with the laser light when the laser light is irradiated, and the first substrate and the second substrate are bonded in the irradiated area.

13. The fluidic device according to claim 11, wherein the penetration area is connected to the flow channel.

14. The fluidic device according to claim 11, further comprising:
a second intermediate layer stacked on the second substrate and made from resin material absorptive to the laser light; and
a third substrate stacked on the second intermediate layer and made from resin material transmissive to the laser light,
wherein the second intermediate layer melts in an area irradiated with the laser light when the laser light is irradiated, and the second substrate and the third substrate are bonded in the irradiated area.
